(19) United States
(12) Patent Application Publication
(10) Pub. No.: US 2007/0279853 A1
(43) Pub. Date: Dec. 6, 2007

(54) Protective cover for display screen of electronic device and electronic device combined with such protective cover

(75) Inventors: Chien-Ju Hung, Taoyuan County (TW); You-Hua Chu, Taoyuan County (TW)

Correspondence Address: BACON & THOMAS, PLLC, 625 SLATERS LANE, FOURTH FLOOR, ALEXANDRIA, VA, 22314, US

(73) Assignee: Lien Yi Technology Co., Ltd., Taipei County (TW)

(21) Appl. No.: 11/445,138

(22) Filed: Jun. 2, 2006

(51) Int. Cl. G06F 1/16

(52) U.S. Cl. 361/683

(57) ABSTRACT

The present invention discloses a protective cover suitable for mounting on a display screen of an electronic device to protect the screen. The protective cover has a convex lens for magnifying the displayed information content. The convex lens can be turned to cover on the surface of the screen, thereby to magnify the information content displayed on the screen. In addition, the convex lens can be used as a magnifying glass when a user intends to read a document paper.

### BACKGROUND OF THE INVENTION

1. Field of the Invention

The present invention relates to a protective cover suitable for mounting on a personal digital assistant (PDA), mobile phone or similar products having a display screen, and in particular to a protective cover having a function of magnifying and displaying.

2. Description of Prior Art

With the rapid development of technology, various information products are proposed. These new-developed information products have integrated various functions to improve their practicability. Further, in order to make the information products easy to carry, the manufactures continuously devote themselves to miniaturize the products.

Since the dimension of the product is more and more compact, the available space of the machine body is limited and thus the display screen equipped on the information product is also limited. Therefore, the size of the display screen on a general hand-held or portable information product is so limited.

Since the screen for displaying the pictures is not big, the massages can be presented in the picture are also restricted. If more massages are to be simultaneously presented in the screen, the only way is to minify the displayed characters or pictures. However, reading the small-sized information presented in the display screen is a laborious job for people who have bad eyesight (such as elders or those who have impaired vision).

In order to solve the above problems, a feasible solution is to expand and transmit the displayed picture of these products having a small screen to play on other big-sized displayer. Further, the product can be design to have a foldable machine body or a sliding cover, so that more space can be extended to expand the screen.

According to the above examples, the inconvenience in reading the information displayed on a small-sized screen may be slightly solved, however, such solution is just an expedient and cannot fundamentally eliminate the inconvenience in reading the information displayed on a small-sized screen.

### SUMMARY OF THE INVENTION

In view of the above problems, that is, the limited size of the screen resulted from the miniaturization of the information product causes the information displayed on the screen too small to be conveniently read, the present invention is achieved to overcome these problems.

The primary object of the present invention aims at a portable device such as PDA or mobile phone and provides a solution capable of magnifying the information displayed on the screen. In this way, the displayed characters or pictures can be magnified and thus are convenient to read. Therefore, the elders and those who have impaired sight can easily read the information displayed on the screen.

In order to achieve the above objects, the present invention provides a protective cover. The protective cover can be combined on an electronic screen and has a convex lens for overlapping the surface of the screen of the electronic device, thereby to magnify the information contents displayed on the screen.

On the other hand, in addition to magnify the displayed information, the protective cover can overlap on the screen surface to protect the screen.

The following embodiment describes in detail the characteristics and advantages of the present invention, so that those skilled in this art can implement this invention in view of the technical contents thereof. Further, according to the disclosure, claims and drawings of the present invention, it is apparent that those skilled in this art will easily understand the objects and other advantages thereof.

### BRIEF DESCRIPTION OF THE DRAWINGS

FIG. 1A is a perspective view showing a preferred embodiment of the present invention;

FIG. 1B is a plan view corresponding to FIG. 1A;

FIG. 2 is an exploded perspective view of the present invention;

FIG. 3 is a front view showing that the protective cover of the present invention adheres on a screen of an electronic device;

FIG. 4 is a schematic view showing another using state of the present invention;

FIG. 5 is a perspective view showing the protective cover of the present invention;

FIG. 6 is a schematic view showing that the protective cover of the present invention can be elastically bent; and

FIG. 7 is a schematic view showing another combined structure of the protective cover of the present invention and the electronic device.

### DETAILED DESCRIPTION OF THE INVENTION

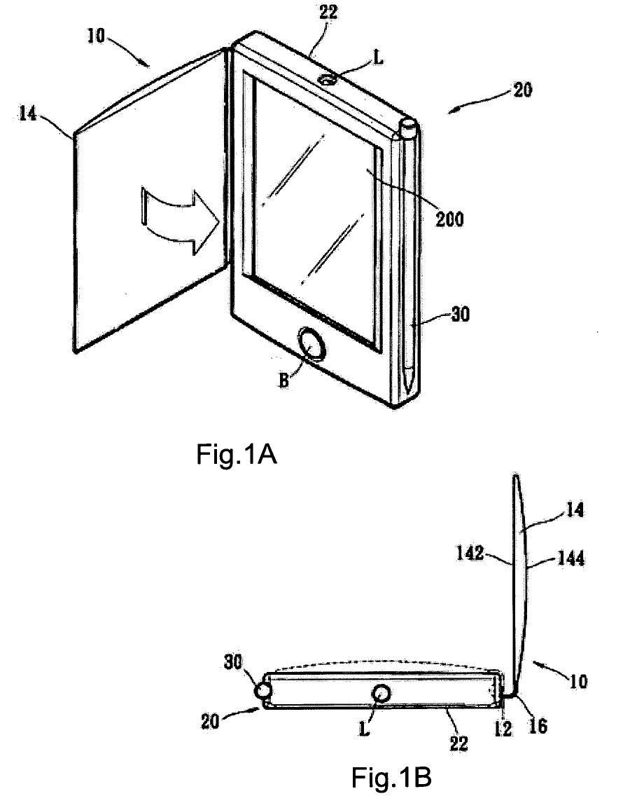

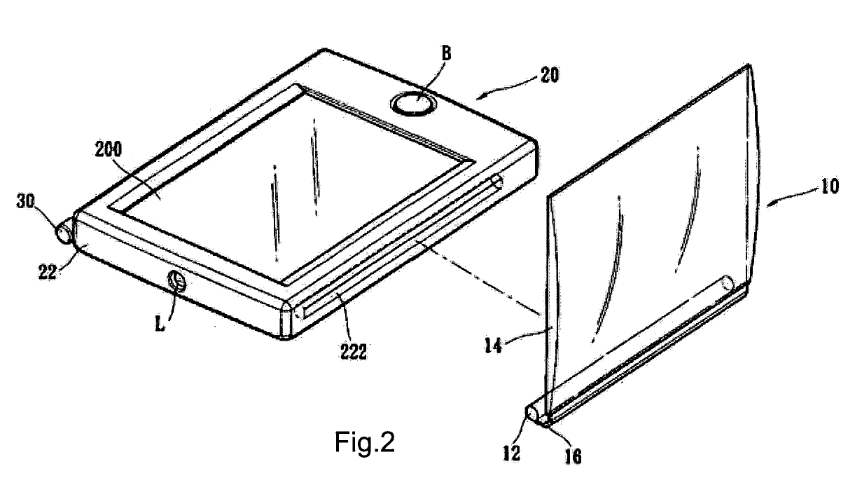

First, with reference to FIG. 1A, it shows a preferred embodiment of the present invention. FIG. 1B is a plan view showing the structure corresponding to that shown in FIG. 1A. The present invention provides a protective cover 10 which can be applied to a PDA, mobile phone and other electronic product 20 having a display screen 200. The protective cover 10 has a convex lens 14 for connecting and overlapping on the surface of the screen 200 of the electronic device 20. In this way, the information contents displayed on the screen 200 can be magnified 14 via the convex lens 14.

In addition, in consideration of elders and kids, the machine body 22 of the electronic device 20 is provided with an emergence call button B. The emergency call button B is electrically connected to a buzzer and control circuit (not shown) built in the electronic device 20. When encountering an emergent situation, the user can press the emergency call button B, so that the buzzer can generate an alarming sound. Further, the top end or other suitable position of the machine body 22 can be provided with a light-emitting element L, such as light-emitting diode (LED) or small-sized bulb. The light-emitting element L is electrically connected to the control circuit of the electronic device 20 for providing the lighting.

As shown in the figures, the protective cover 10 of the present invention comprises a connecting piece 12 and a convex lens 14 connected to the connecting piece 12. The protective cover 10 is connected to the side edge of the electronic device 20 via the connecting piece 12. Further, the protective cover is able to rotate relative to the electronic device 20, so that the convex lens 14 can overlap or adhere on the surface of the screen 200.

As a result, the picture displayed on the screen 200 can be magnified by means of the convex lens 14 overlapping on its surface. The convex lens 14 is made of a light-pervious material. On surface of the convex lens is formed into a plane 142 and the other surface is formed into a convex surface 144, thereby to produce a magnified visual effect.

In use, the protective cover 10 can be a member fixed on the electronic device 20 or a detachable member additionally assembled on the electronic device 20. In a preferred embodiment of the present invention, the protective cover 10 and the electronic device 20 can be detached from each other or combined with each other. As shown in FIG. 2, one side of the machine body 22 is provided with a connecting groove 222 for connecting the protective cover 10. The connecting groove 222 on the machine body 22 is an axially elongated groove with both ends closed and is used for the insertion of the protective cover 10.

The connecting piece 12 is an elongated rod. The connecting piece can be inserted into the connecting groove 222 on the side edge of the machine body 22. Thus, the connecting piece and the machine body 22 are tightly connected and cannot be easily detached from each other. It can be seen from the drawing that the cross section of the connecting groove 222 on the side edge of the machine body 22 is substantially circular. Therefore, after the connecting piece 12 is inserted into the connecting groove 222, the cylindrical connecting piece 12 can axially rotate in the connecting groove 222.

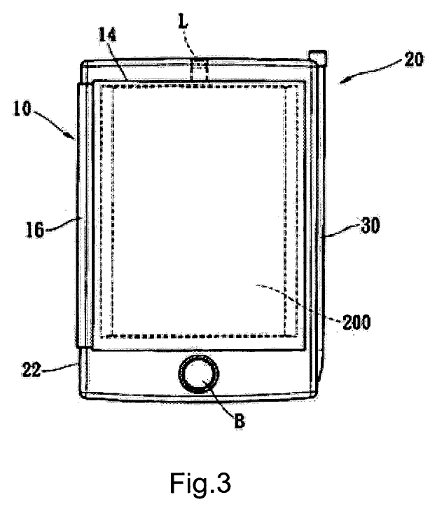

In this way, the convex lens 14 connected on the connecting piece 12 can be controlled to turn relative to the electronic device 20 by using the rotatable connecting piece 12. As a result, when the user intends to read the information displayed on the screen 200, he/she just only turns the convex lens 14 to overlap or adhere on the surface of the screen 200 by rotating the connecting piece 12. Therefore, the user can read the information content on the screen 200 that is magnified by the convex lens 14 (as shown in FIG. 3). Further, if the user intends to use a stylus 30 to perform a touch-control action on the screen 200 of the electronic device 20, the convex lens 14 can be turned to the position not interfering with the above action. According to the above, the protective cover 10 is a member pivotably connected to the electronic device 20 via the connecting piece 12, and it can be turned to different positions depending on the conditions in use.

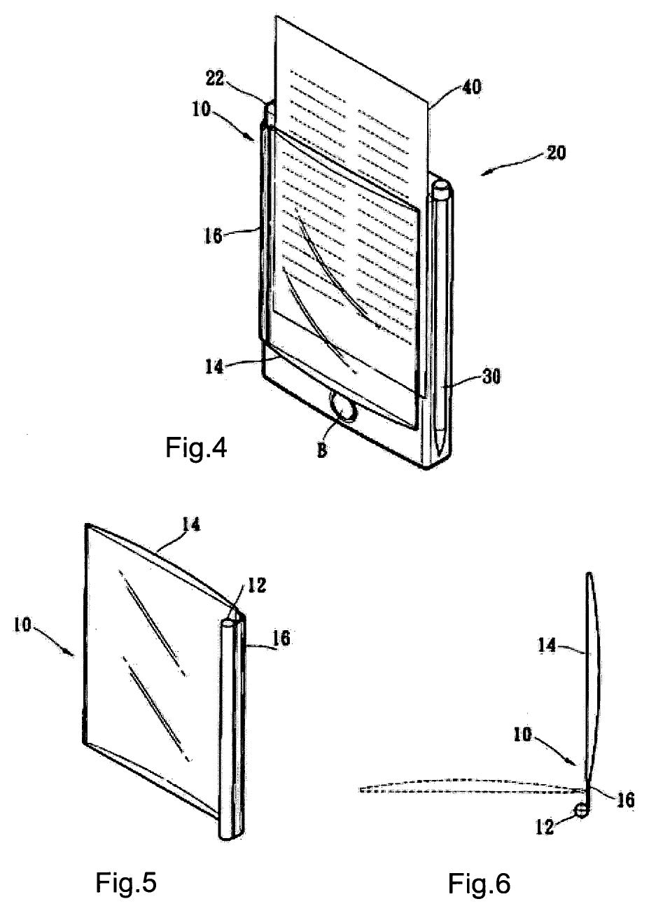

Incidentally, when the protective cover 10 is connected to the electronic device 20, the convex lens 14 can be used as a magnifying glass for a document paper 40, as shown in FIG. 4. If only the document paper 40 adheres on the back surface of the convex lens 14 or is sandwiched in the gap between the convex lens 14 and the screen 200, the content on the document paper 40 can be magnified via the convex lens 14.

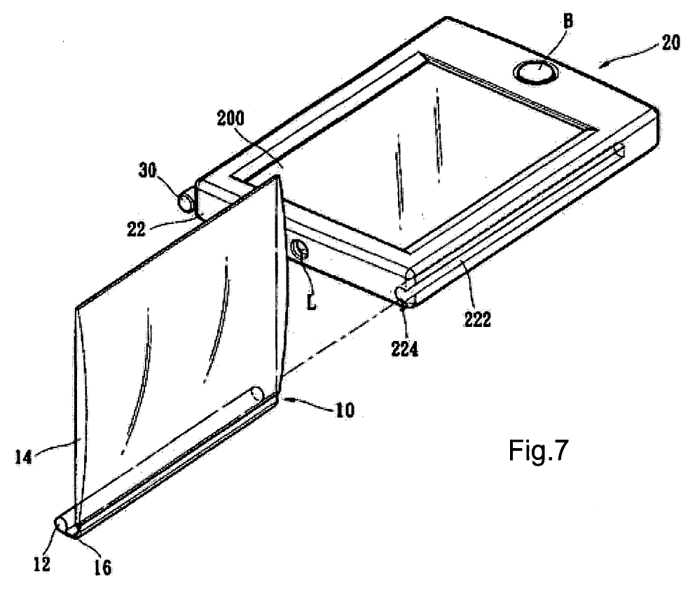

With reference to FIG. 5, it is a perspective view of the protective cover 10 of the present invention. The protective cover 10 comprises a connecting piece 12 and a convex lens 14. The connection between the connecting piece 12 and the convex lens 14 is indirectly achieved by an interconnecting piece 16 made of a rigid material, so that the convex lens 14 and the connecting piece 12 can rotate synchronously relative to the electronic device 20. In practice, the interconnecting piece 16 can be selectively made of an elastic material. In the embodiment disclosed in FIG. 6, when the connecting piece 12 of the protective cover 10 has elasticity, the turning of the convex lens 14 is not necessarily achieved by the synchronous action of the connecting piece 12. In other words, after the connecting piece 12 is connected on the electronic device 20, if the connection between these two members cannot make the connecting piece 12 to rotate, the angle of the convex lens 14 can still be adjusted by means of the turning of the connecting piece 12, thereby to produce the turning of the convex lens.

FIG. 7 shows another aspect of connection between the protective cover 10 and the electronic device 20. In this example, the connecting groove 222 provided on the side edge of the electronic device 20 is closed at one end, and the other end thereof is provided with a sliding groove having an opening 224. Therefore, the connecting piece 12 of the protective cover can be connected on the electronic device 20 by inserting through the opening 224 of the sliding groove.

According to the above, the protective cover 10 of the present invention indeed has industrial applicability, novelty and inventive steps. Although the present invention has been described with reference to the foregoing preferred embodiments, it will be understood that the invention is not limited to the details thereof. Various equivalent variations and modifications can still be occurred to those skilled in this art in view of the teachings of the present invention. Thus, all such variations and equivalent modifications are also embraced within the scope of the invention as defined in the appended claims.

What is claimed is:

1. A protective cover for a display screen of an electronic device, the protective cover connected on the electronic device and provided with a convex lens for overlapping on the surface of the screen of the electronic device, thereby to magnify the information content displayed on the screen.

2. The protective cover for a display screen of an electronic device according to claim 1, wherein one surface of the convex lens is formed into a plane and the other surface is formed into a convex surface.

3. A protective cover for a display screen of an electronic device, comprising:
a connecting piece for connecting on an electronic device; and
a convex lens connected to the connecting piece and overlapping on the surface of the screen of the electronic device, thereby to magnify the information content displayed on the screen.

4. The protective cover for a display screen of an electronic device according to claim 3, wherein the connecting piece is pivotably connected to the electronic device.

5. The protective cover for a display screen of an electronic device according to claim 3, wherein one surface of the convex lens is formed into a plane and the other surface is formed into a convex surface.

6. The protective cover for a display screen of an electronic device according to claim 3, wherein the connecting piece is connected to the protective cover via an interconnecting piece.

7. The protective cover for a display screen of an electronic device according to claim 6, wherein the interconnecting piece is made of a rigid material.

8. The protective cover for a display screen of an electronic device according to claim 6, wherein the interconnecting piece is made of an elastic material.

9. An electronic device, comprising:
a machine body having a display screen, the machine body provided with a connecting groove thereon; and
the protective cover according to claim 3, the connecting piece of the protective cover connected into the connecting groove.

10. The electronic device according to claim 9, wherein the connecting groove provided on the machine body is an elongated groove with both ends closed.

11. The electronic device according to claim 9, wherein the connecting groove provided on the machine body is closed at one end and is provided at the other end with a sliding groove having an opening.

12. The electronic device according to claim 9, wherein the connecting piece is an elongated rod, and the connecting groove receives the connecting piece and allows the connecting piece to rotate therein.

13. The electronic device according to claim 9, wherein the machine body is provided with an emergence call button thereon.

14. The electronic device according to claim 9, wherein the machine body is provided with a light-emitting element thereon.
